(19) United States
(12) Patent Application Publication
(10) Pub. No.: US 2013/0130190 A1
(43) Pub. Date: May 23, 2013

(54) Orthodontic Force Module Including Elastomeric Member for Class II and Class III Correction

(71) Applicant: Paul E. Lewis, Midvale, UT (US)

(72) Inventor: Paul E. Lewis, Midvale, UT (US)

(73) Assignee: ULTRADENT PRODUCTS, INC., South Jordan, UT (US)

(21) Appl. No.: 13/814,238

(22) PCT Filed: Jul. 27, 2011
(86) PCT No.: PCT/US11/45447

§ 371 Date: Feb. 4, 2013

Related U.S. Application Data
(60) Provisional application No. 61/370,952, filed on Aug. 5, 2010.

(51) Int. Cl. A61C 7/36; A61C 7/00

(52) U.S. Cl. CPC A61C 7/36; A61C 7/00
USPC 433/19; 433/18

(57) ABSTRACT

Orthodontic force modules for use in correcting class II and/or class III malocclusions. In one embodiment, the force module (100) includes an elongate body (102) extending between a distal end (104) and a proximal end (106), a movable member (108) extending between a proximal end (112) and a distal end (110) that is slidably disposed relative to the elongate body (102), a movable piston (108) disposed at or near the distal end (110) of the movable member, a stop (118) disposed at or near a proximal end (106) of the elongate body (102) and proximal to the movable piston (108), and an elastomeric member (120). A proximal end (112) of the elastomeric member (120) is cooperatively coupled to the stop (118), while a distal end (110) is cooperatively coupled to the movable piston (108) so that when the movable member is moved distally relative to the body, the elastomeric member (120) stretches so as to apply a counter-force to the movable member (108).

### BACKGROUND OF THE INVENTION

1. The Field of the Invention

The present invention is in the field of orthodontics, more particularly in the field of devices for correction of class II and/or class III malocclusions.

2. The Relevant Technology

Orthodontics is a specialized field of dentistry that involves the application of mechanical forces to urge poorly positioned or crooked teeth into correct alignment and orientation. Orthodontic procedures can be used for cosmetic enhancement of teeth, as well as medically necessary movement of teeth to correct overjets and/or overbites. For example, orthodontic treatment can improve the patient's occlusion, or enhanced spatial matching of corresponding teeth.

The most common form of orthodontic treatment involves the use of orthodontic brackets and wires, which together are commonly referred to as “braces.” Orthodontic brackets are small slotted bodies configured for direct attachment to the patient's teeth or, alternatively, for attachment to bands which are, in turn, cemented or otherwise secured around the teeth. Once the brackets are affixed to the patient's teeth, such as by means of glue or cement, a curved arch wire is inserted into the bracket slots.

The brackets and the arch wire cooperate to guide corrective movement of the teeth into proper alignment. Typical corrective movements provided by orthodontic treatment can include torque, rotation, angulation, leveling, and other movements needed to correct the spacing and alignment of misaligned teeth.

The orthodontic treatment of some patients includes correction of the alignment of the upper dental arch relative to the lower dental arch. Certain patients have a condition referred to as a Class II malocclusion wherein the lower dental arch is located an excessive distance rearward of the upper dental arch when the jaws are closed (retrognathia). Other patients may have an opposite condition referred to as a Class III malocclusion wherein the lower dental arch is located forward of the upper dental arch when the jaws are closed (prognathia).

Class II and Class III malocclusions may be corrected with use of a force-applying system such as headgear or an intraoral force module. Headgear is generally disfavored because it is bulky and often a source of embarrassment for the patient. Intraoral force modules have gained increased acceptance as they can remain fixed in place over the course of treatment so as to typically not be removable by the patient, and are less aesthetically objectionable as compared to traditional headgear. Although existing intraoral force modules represent an improvement over headgear, there are still opportunities for substantial improvement.

### SUMMARY OF THE INVENTION

The present invention is directed to orthodontic force modules for use in correcting class II and/or class III malocclusions. In one embodiment, the force module includes an elongate body extending between a distal end and a proximal end; a movable member (e.g., a piston rod) extending between a distal end and a proximal end in which the distal end of the movable member is slidably disposed relative to the body; a movable piston disposed at or near the distal end of the movable member; a stop disposed at or near the proximal end of the body, the stop being proximally disposed relative to the movable piston; and an elastomeric member extending between the stop and movable piston. A first end of the elastomeric member is cooperatively coupled to the stop, and a second end of the elastomeric member is cooperatively coupled to the movable piston. When the movable member is pressed or otherwise moved distally relative to the body, the elastomeric member stretches so as to apply a counter-force to the movable member.

The use of an elastomeric member (e.g., comprising silicone or a thermoplastic elastomer) rather than a coil spring is advantageous for several reasons. First, the use of an elastomeric member rather than a coil spring is more comfortable for the patient, as coil springs, typically made of metal, can pinch and/or poke the soft interior tissues (e.g., cheeks) within the patient's mouth. The present orthodontic force module does not require the use of a coil spring, preventing such injuries to the patient. Furthermore, the inventor has found that silicone and preferred thermoplastic elastomeric materials retain their elasticity over time, even when subjected to relatively harsh environments within the oral cavity. Because of the stability of the material's elasticity over time and under such conditions, the force modules are able to apply the desired level of force for movement of the jaw so as to correct a class II or a class III malocclusion without any significant reduction in the level of applied force during treatment. This is helpful as it reduces overall treatment time as compared to devices that include a coil spring. For example, coil springs may exhibit a progressively diminishing level of force after installation. Often, return appointments with the orthodontist are required in order to replace and/or readjust such force modules once the level of force being applied drops below a given threshold.

In one embodiment, the elongate body of the orthodontic force module is configured with a substantially oval cross-section. The device is configured so that the long axis of the oval is substantially vertical during use (i.e., a tall, skinny configuration rather than a short, fat configuration). Such a configuration is particularly advantageous as the space within the oral cavity between the jaw and the inside of the patient's cheek, particularly near the molars, is relatively limited. Providing a substantially oval cross-section minimizes the width (i.e., the short axis of the oval) required by the orthodontic force module so that it fits more easily into the available space with minimal discomfort to the patient.

Although it is preferred that the use of metal or other coil springs for providing the counter-force to the piston rod or other movable member be avoided, according to one embodiment, it is within the scope of the invention to employ such force members while providing an orthodontic force module having a non-circular cross section in which the width of the body of the module is reduced (e.g., having an oval or D-shaped cross-section) as compared to a round cross-section. Such a force module typically includes a movable member (e.g., a piston rod) and some type of force member disposed on (e.g., adjacent the exterior) or within the body that is cooperatively coupled to the movable member such that when the movable member is urged distally relative to the elongate body, the force member applies a counter-force to the movable member. Although preferably such a force member comprises an elastomeric member, it is also within the scope of the invention to alternatively employ a coil spring or other force member in such an embodiment including a non-circular body.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. The drawings depict only typical embodiments of the invention and are not therefore to be considered limiting of its scope.

FIG. 1A is a perspective and partial cross-sectional view of an exemplary orthodontic force module;

FIG. 1B is a perspective and partial cross-sectional view of the force module of FIG. 1A in which the movable member has been urged into the elongate body;

FIG. 1C is an exploded view of the force module of FIG. 1A;

FIG. 1D is a transverse cross-sectional view through the force module of FIG. 1A;

FIG. 1E is a transverse cross-sectional view through a force module showing an alternative configuration;

FIG. 2A is a perspective and partial cross-sectional view of another exemplary orthodontic force module;

FIG. 2B is a perspective and partial cross-sectional view of the force module of FIG. 2A in which the movable member has been urged into the elongate body;

FIG. 2C is a transverse cross-sectional view through the force module of FIG. 2A;

FIG. 3A is a perspective and partial cross-sectional view of another exemplary orthodontic force module;

FIG. 3B is a perspective and partial cross-sectional view of the force module of FIG. 3A in which the movable member has been urged into the elongate body;

FIG. 4 is a perspective and partial cross-sectional view of an alternative force module including a telescoping outer housing;

FIG. 5A is a perspective and partial cross-sectional view of an alternative force module configured to include twin elongate bodies and twin movable members;

FIG. 5B is a transverse cross-sectional view through the force module of FIG. 5A;

FIG. 6 is a perspective and partial cross-sectional view of another alternative force module;

FIG. 7A is a perspective view of a patient's upper and lower jaws in which the force module of FIG. 1A has been installed between the upper and lower jaws to correct a class II malocclusion;

FIG. 7B is a perspective view similar to FIG. 7A, but in which the patient's mouth is opened, opening the space between the upper and lower jaws and in which the movable member partially retracts out from the elongate body so as to accommodate the increased space between the jaws; and

FIG. 7C is a cross-sectional view through the patient's upper and lower jaws and cheek showing the relatively limited space between the jaws and the interior of the patient's cheek, particularly near the posterior portion of the jaws adjacent the molars.

### DETAILED DESCRIPTION OF THE PREFERRED EMBODIMENTS

### I. Introduction

The present invention is directed to orthodontic force modules for use in correcting class II and/or class III malocclusions. In one embodiment, the force module includes an elongate body extending between a distal end and a proximal end; a movable member extending between a proximal end and a distal end that is slidably disposed relative to the elongate body; a movable piston disposed at or near the distal end of the movable member; a stop disposed at or near a proximal end of the elongate body and proximal to the movable piston; and an elastomeric member. A proximal end of the elastomeric member is cooperatively coupled to the stop, while a distal end is cooperatively coupled to the movable piston so that when the movable member is moved distally relative to the body, the elastomeric member stretches so as to apply a counter-force to the movable member.

When the force module is attached between teeth of the upper and lower jaw (e.g., for class II correction, the proximal end of the movable member may be attached to a lower canine while the distal end of the elongate body may be attached to a posterior tooth (e.g., a molar) of the upper jaw) the counter force is applied so as to move the jaws relative to one another so as to correct the malocclusion.

### II. Exemplary Orthodontic Force Modules

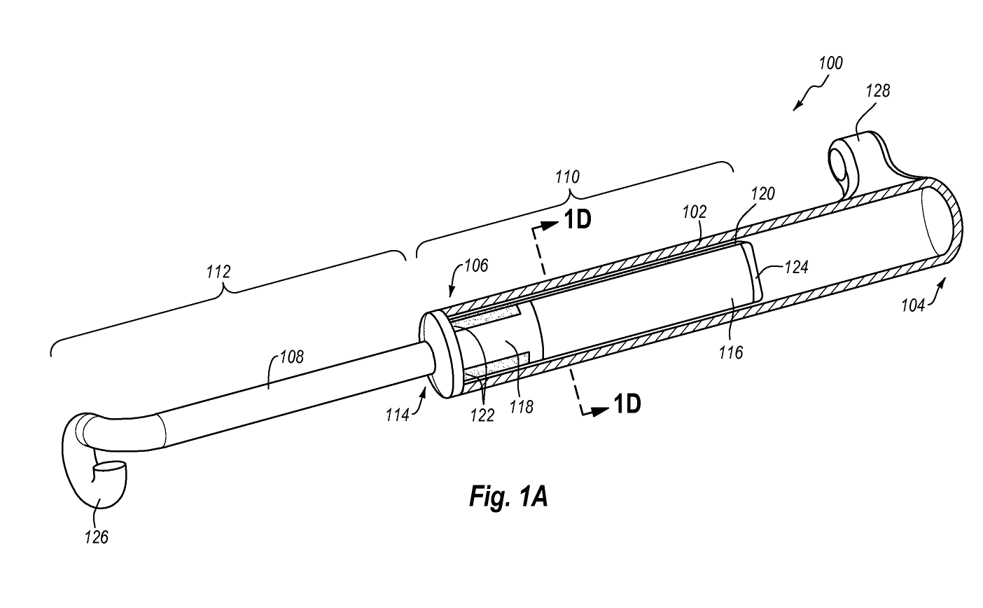

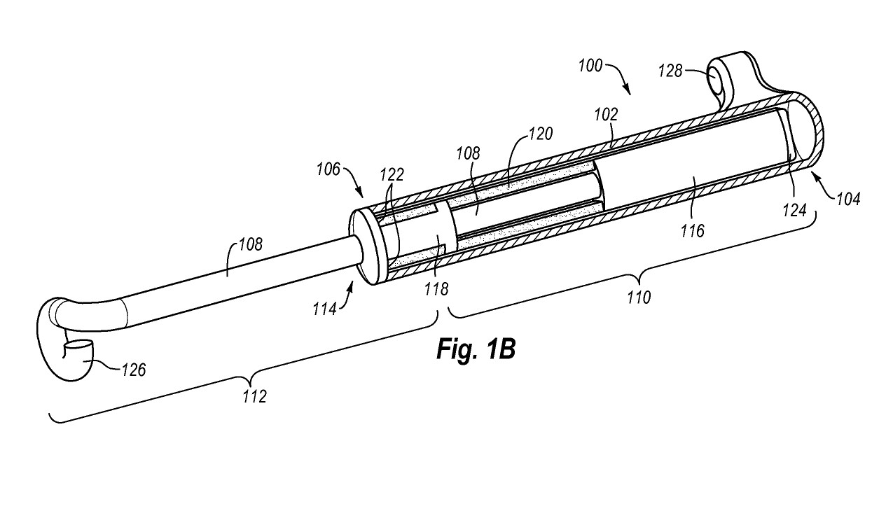

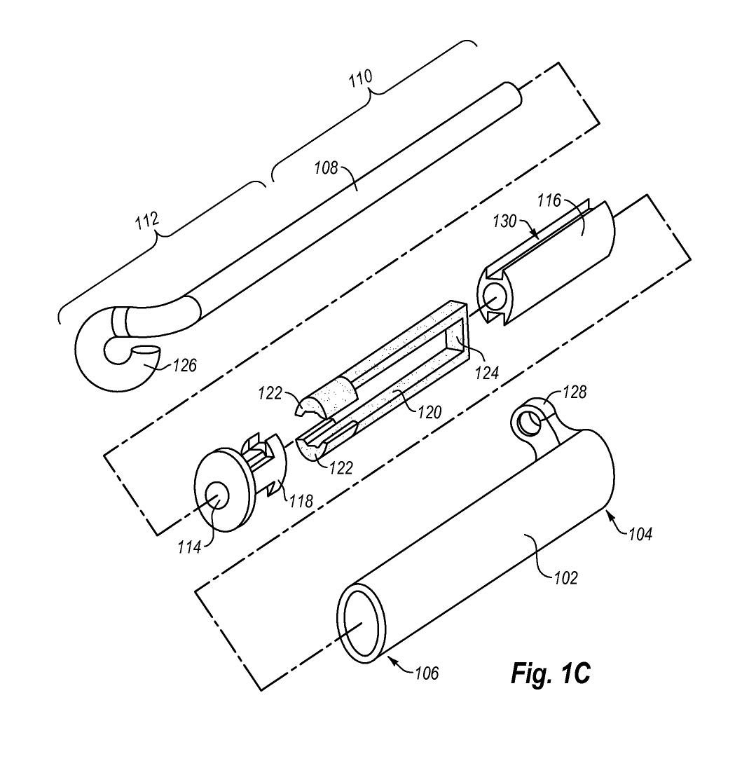

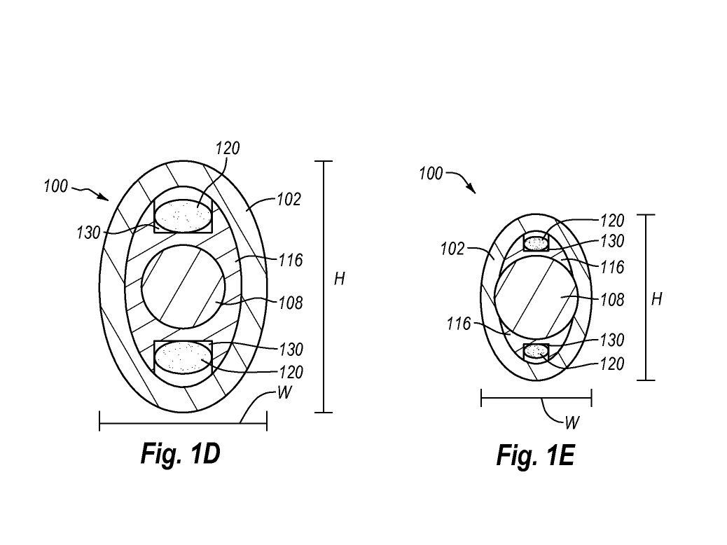

FIGS. 1A-1E show an exemplary force module 100 including an elongate body 102 extending between a distal end 104 and a proximal end 106. A movable member 108 (e.g., a piston rod) also includes a distal end 110 and a proximal end 112. In the illustrated embodiment, distal end 110 is slidably disposed through opening 114 formed through proximal end 106 of body 102 so as to be disposed within a cavity in body 102. Opening 114 (e.g., a hole) may be centrally disposed, and aids in alignment of movable member 108 as it enters elongate body 102. Movable piston 116 is disposed at or near distal end 110 of movable member 108. In the illustrated embodiment, movable piston 116 is slidably movable within body 102. Stop 118 is disposed at or near proximal end 106, also within body 102. In one embodiment, stop 118 is fixed relative to body 102. As seen in FIGS. 1B-1C, an end 122 of an elastomeric member 120 (e.g., configured as an elongate band) is cooperatively coupled to stop 118, while another end 124 of elastomeric member 120 is cooperatively coupled to movable piston 116. Such a configuration stretches elongate elastomeric member 120 so that member 108 is urged into elongate body 102 as movable member 108 and movable piston 116 slide distally into body 102 relative to proximal end 106. Cooperative coupling of elastomeric member 120 to stop 118 and piston 116 may be accomplished by any suitable mechanism. Elastomeric member 120 may be attached so as to fix (e.g., with a adhesive) the elastomeric member 120 to stop 118 and/or piston 116. Alternatively, the elastomeric member 120 may simply be removably engaged with stop 118 and piston 116 (e.g., seated within a groove or other feature). In any case, the components cooperate with one another (e.g., stop 118 and piston 116 aid in applying tension to elastomeric member 120) during operation to selectively tension elastomeric member 120. As such, band 120 may or may not be fixedly attached to stop 118 and piston 116. In embodiments where not fixedly attached, it may be possible to remove elastomeric member 120 from coupled engagement with stop 118 and/or piston 116.

FIG. 1B shows a configuration in which movable member 108 has been pressed or otherwise moved further into body 102, causing the distal end 110 of movable member 108 and movable piston 116 to slide distally within body 102. Stop 118 anchors end 122 of elastomeric member 120 in place. In this configuration, elastomeric member 120 is under tension and applies a counter-force to movable member 116 and movable member 108. When force is released from movable member 108, member 108 retracts from elongate body 108, back to the configuration shown in FIG. 1A.

When installed and during use, force module 100 assumes a configuration as shown in FIG. 1B when the patient's mouth is closed. When the patient's mouth is opened, the configuration of FIG. 1A is assumed. While the patient's mouth is closed elastomeric member 120 applies a counter force to movable piston 116 through movable member 108, and to either an upper or lower jaw to which movable member 108 is attached. This counterforce results in the desired movement of one jaw relative to another so as to correct the class II or class III malocclusion.

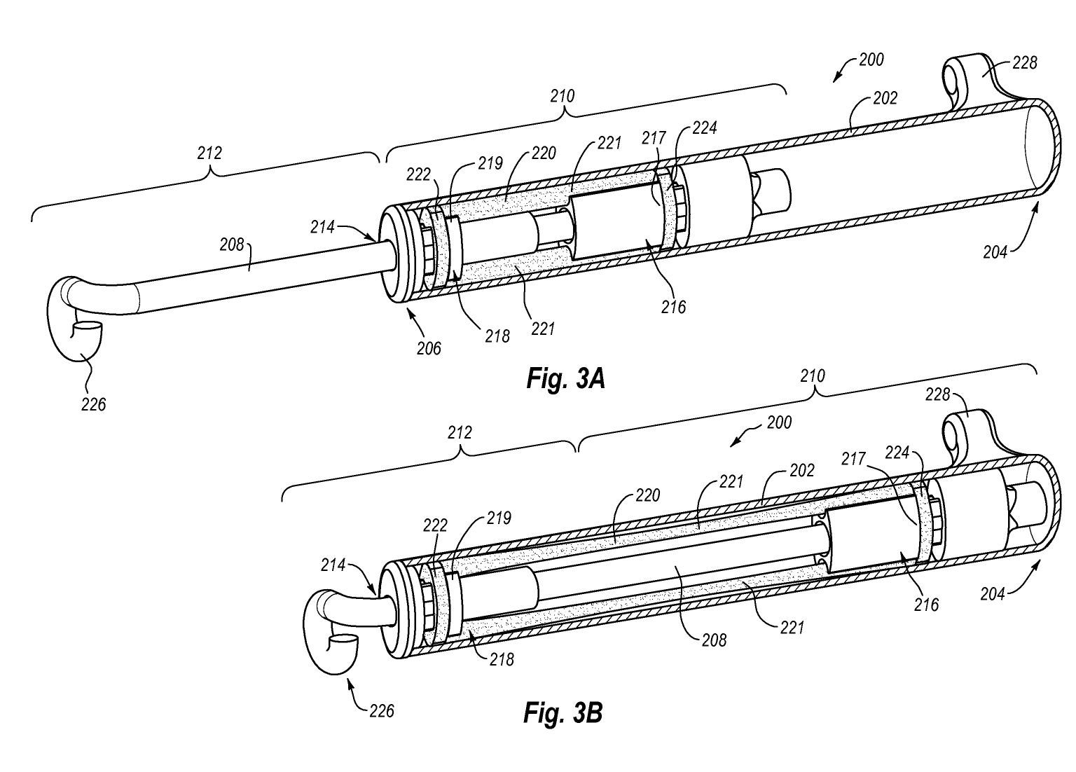

As perhaps best seen in FIG. 1D, movable piston 116 may include a groove 130 within which elastomeric member 120 is seated, cooperatively coupling elastomeric member 120 with piston 116. In one embodiment, elastomeric member 120 may simply comprise an elastomeric band that is seated within exterior grooves formed within movable piston 116, as well as within exterior grooves formed within stop 118. In another embodiment, elastomeric band 120 and/or stops 116 and 118 may include alternative structural features for engagement with the respective stops. FIGS. 3A-3B illustrate one such alternative configuration. Grooves provide a simple coupling mechanism between stop 118, piston 116, and elastomeric member 120. Alternative cooperative coupling mechanisms will be apparent to one of skill in the art.

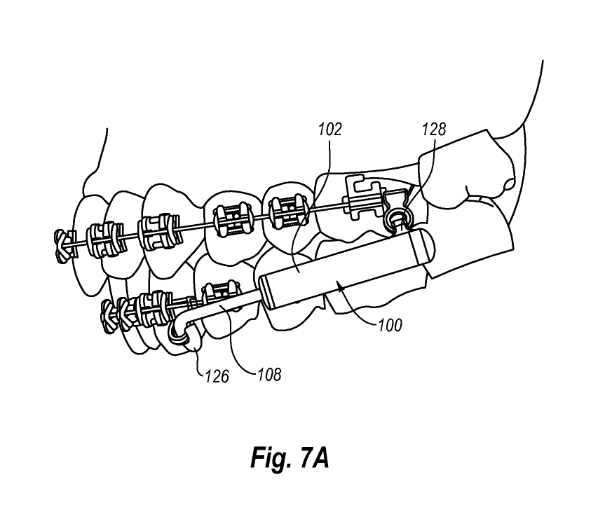

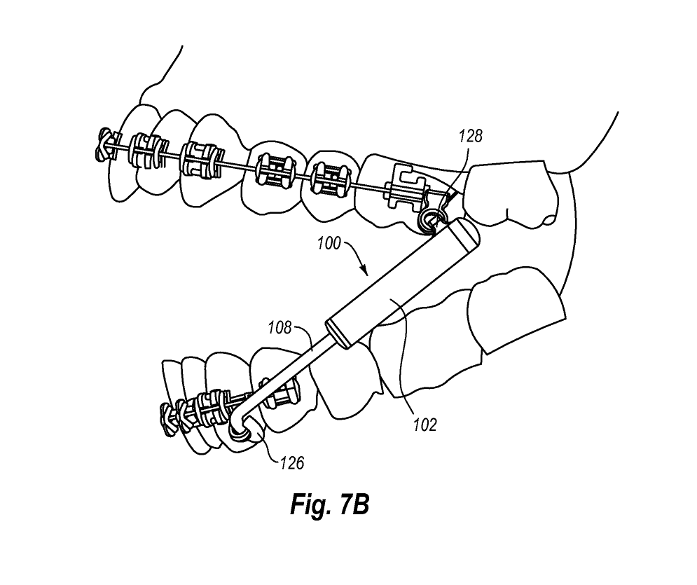

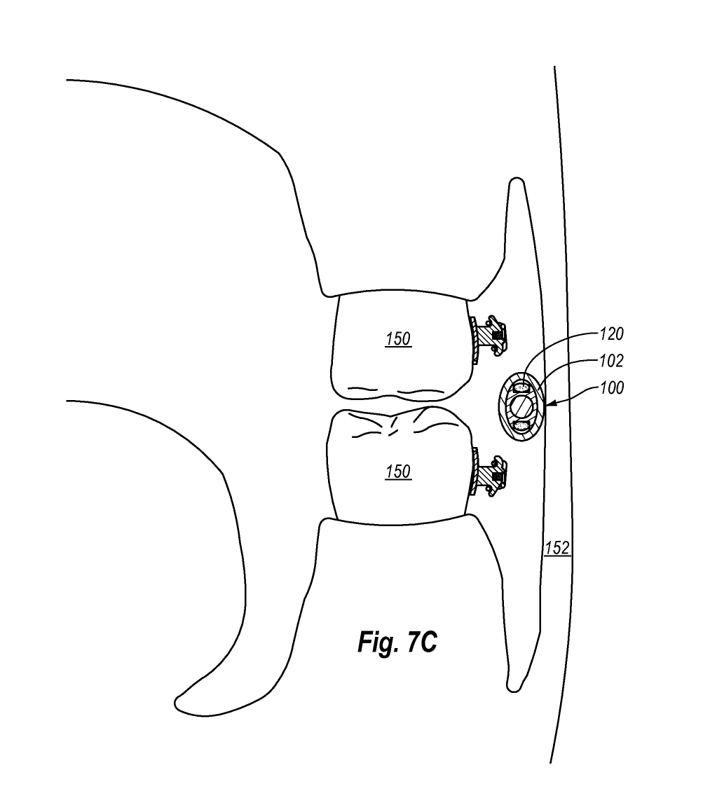

Attachment means (e.g., a hook 126) is provided at or near proximal end 112 of piston rod 108 for attaching the proximal end of the force module 100 to an orthodontic bracket or arch wire on a dental arch (see FIGS. 7A-7B). Another hook 128 or other attachment means is provided at or near distal end 104 of elongate housing 102 for attaching the distal end of force module 100 to a bracket or arch wire on the other dental arch during use. Attachment with such hooks or other attachment structure allows the counter-force provided by elastomeric member 120 to movable member 108 to be transferred through hook 126 to the jaw via a bracket or arch wire to which hook 126 is connected. Hook 128 provides an anchor to a bracket or arch wire on the opposite jaw. Illustrated hook 128 includes a hole running in a direction that is substantially parallel to a longitudinal axis of module 100. In an alternative embodiment, hook 128 may alternatively or additionally include a hole running in a direction generally transverse to that of the illustrated embodiment (i.e., substantially perpendicular to a longitudinal axis of the module 100). One of skill in the art will appreciate that any known attachment means may be employed for engaging each end of the force module 100 with the patient's upper and lower jaws.

FIG. 1D is a transverse cross-sectional view through force module 100 along lines 1D-1D. As perhaps best seen in this figure, elongate body 102 may have a substantially oval cross-sectional shape. Although other shapes are possible (e.g., circular, square, rectangular, or other shape), a substantially vertically oriented oval is particularly preferred as it includes a width W that is relatively narrow. The relatively tall and narrow cross-sectional shape of the oval is particularly advantageous as it minimizes the width required by the force module between the jaw and the cheek when the force module is installed (see FIG. 7C). Other non-circular cross-sections that include a height axis H that is greater than the width axis W may also provide similar advantages. For example, besides the described oval configuration, another such cross-sectional shape that may provide similar advantages of reduced width as compared to a circular cross-section may be a D-shape cross section. In one embodiment, such a D-cross-sectional shape may resemble an oval in which a portion of the “long” vertically oriented right or left sides has been removed (i.e., a half-oval). The thickness of elongate body 102 in FIG. 1D may be substantially constant throughout.

FIG. 1E illustrates an alternative configuration in which the wall thickness of body 102 is not constant, but includes portions adjacent movable member 108 where the wall thickness is at a minimum. Elongate body 102 may be formed by machining a suitable metal or other material, for example, by removing material (e.g., drilling out) from a center portion through which movable member 108 will be received. Such a configuration as shown in FIG. 1E further minimizes the width of the body 102 for increased patient comfort, while still providing sufficient strength within the walls of body 102 so as to minimize or prevent breakage. Strength is particularly enhanced when forming the elongate body by machining, as a relatively large wall thickness may be achieved while also minimizing width W. Although machining is preferred, other manufacturing techniques (e.g., casting, metal injection molding, drawing, etc.) may alternatively be employed.

Although metal is preferred, it may be possible to employ other materials such as plastics (e.g., polycarbonate, nylon, and/or Delrin, any of which may be glass loaded for reinforcement), or even ceramic. Any suitable metal material may be employed, including but not limited to, stainless steel and/or a cobalt chromium alloy. Various exemplary stainless steels include ANSI 17-4, ANSI 400 series stainless steels, and/or ANSI 300 series stainless steels (e.g., ANSI 303, ANSI 304, and/or ANSI 316).

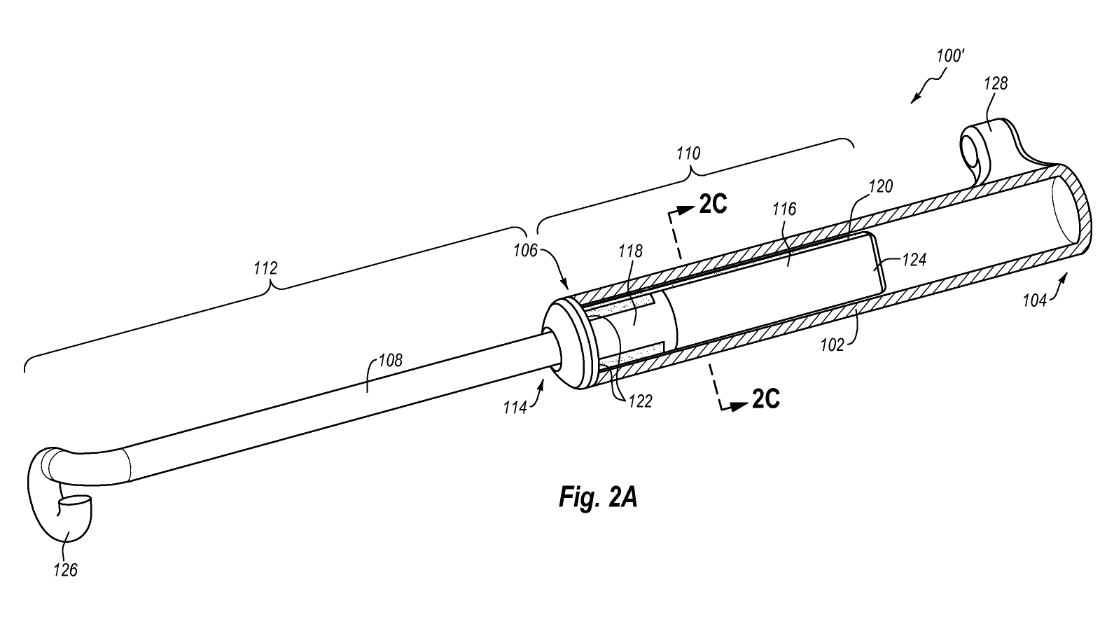

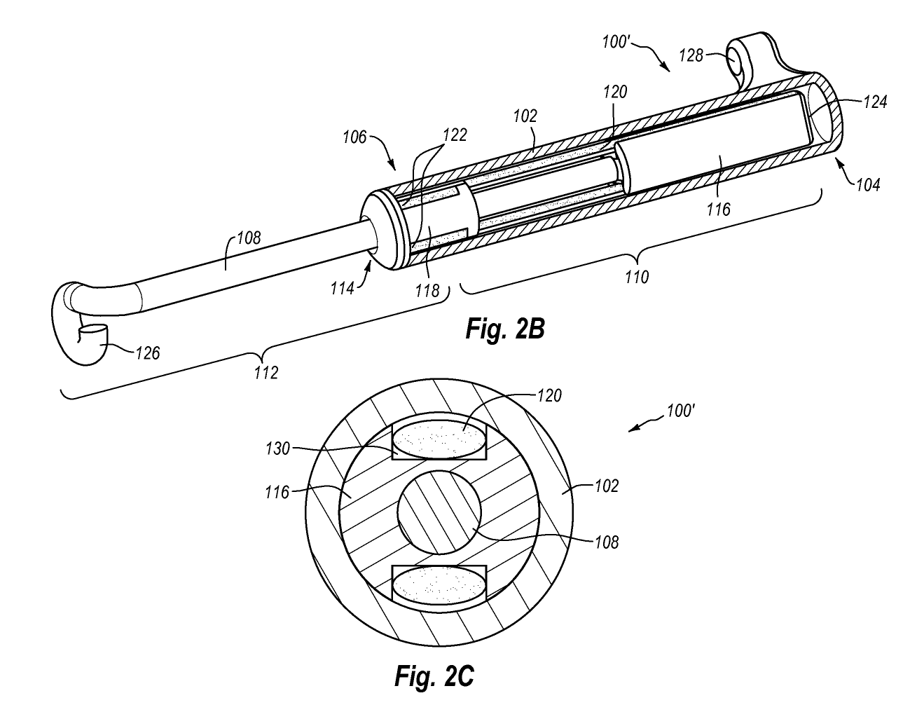

FIGS. 2A-2C illustrate an alternative orthodontic force module 100′ that is otherwise similar to force module 100 but includes a substantially circular transverse cross section, as perhaps best seen in FIG. 2C.

Module 100 having a substantially oval transverse cross-section has a ratio of height H (i.e., the long, substantially vertical axis) to width W (i.e., the short, substantially horizontal axis) that is between about 1.1:1 and about 2:1. More preferably, the ratio of the long axis to the short axis of the oval is between about 1.3:1 and about 1.7:1. Most preferably, the ratio of the long axis to the short axis of the oval is between about 1.4:1 and about 1.6:1 (e.g., about 1.5:1). Such ovals are substantially vertically oriented (i.e., the axis defined by dimension H is oriented in a substantially gingival-occlusal direction) during use as seen in FIG. 7C, minimizing the width of the device so that it is more easily accommodated between the jaws and interior cheek of the patient. Of course, the substantially circular configuration of FIG. 2C includes a ratio of height to width that is about 1:1.

As shown in the illustrated configuration, elongate body 102 may advantageously be substantially closed, providing a substantially sealed environment for movable piston 116, stop 118, and elastomeric member 120. For example, the only opening may be hole 114 through which movable member 108 enters body 102. Preferably, movable piston 116, stop 118, and elastomeric member 120 are housed completely within elongate body 102 so as to prevent accumulation and contamination by debris and/or foreign material. Furthermore, as shown, the exterior surface of body 102 is preferably smooth to further minimize accumulation of such material on the exterior surface of body 102. Of course, it is within the scope of the invention to provide an elongate body that is not substantially smooth and closed. Furthermore, although perhaps not preferred, it is also within the scope of the invention to position one or more of the movable member, stop, movable piston, or the elastomeric band on an exterior surface of the elongate body.

Exemplary silicone and thermoplastic elastomer materials suitable for use preferably exhibit elastic elongation of at least about 50%, more preferably at least about 75%, even more preferably at least about 100%, and most preferably at least about 300%. Accordingly to one embodiment, the elastic elongation is in a range of about 50% to about 2000%, preferably in a range of about 75% to about 1500%, more preferably in a range of about 100% to about 1000%, and most preferably in a range of about 300% to about 800%.

The employed elastomeric material may include any suitable durometer hardness value. Durometer is a measure of the hardness, or ability of the material to resist permanent indentation. Specific ASTM testing procedures (e.g., ASTM D2240) will be known to those of skill in the art. Typical durometer values may range between a Shore A durometer hardness between about 20 and about 90. The higher the value, the harder the material. Materials exhibiting even higher hardness values (e.g., those measured on the Shore D scale) may also be used. The particular durometer hardness value selected will depend on the elastic elongation value of the particular elastomeric material, as well as the cross-sectional shape and thickness of the elastomeric member being employed. For example, it may be desirable to for the elastomeric member to provide between about 80 g and about 600 g, more typically between about 80 g and about 450 g of force during use. In one embodiment, the force may be not more than about 200 g (e.g., about 80 g to about 200 g, perhaps about 180 g). In another embodiment, the force may be between about 200 g and about 250 g. In another embodiment, the force may be between about 250 g and about 300 g. Although any force value or range may be used with any particular patient, in one embodiment force values not greater than about 200 g may be optimal for an older adult, while about 200 g to about 250 g may be optimal for a middle age adult. About 250 g to 300 g may be optimal for an adolescent patient.

Parameters such as durometer hardness, elastic elongation, and cross-sectional shape and size of the elastomeric member may all be varied to achieve the desired level of force. Furthermore, because these variables may be relatively easily adjusted in the manufacture of the elastomeric member, it is possible to provide a force tailored to the practitioner's desire. For example, a lower durometer hardness value will generally result in a decrease in applied counter-force. A lower elastic elongation value will generally result in an increase in applied counter-force. An increase in cross-sectional area of the elastomeric member will generally result in an increase in applied counter-force. Such variability and adjustability is often not possible with devices employing metal springs for application of the counter-force. For example, existing devices employing metal springs are all configured to apply approximately the same level of force (e.g., perhaps about 180 g). Embodiments of the present invention including elastomeric force members provide the practitioner with the ability to use a force module configured to provide a different level of force (e.g., between about 80 g and about 160 g, or between about 200 g and about 450 g) that is selected because it provides optimal results in the case of the given patient. Of course, the selected force module may deliver a force similar to that provided by existing coil spring devices (e.g., perhaps about 180 g).

According to one embodiment, two or more orthodontic force modules may be provided, each configured to provide a different level of force. According to a related method of use, two force modules providing different levels of force may be installed within the patient's mouth (e.g., on different sides) at the same time so as to apply more force on one side relative to the other side. For example, according to one embodiment both force modules may provide a force broadly between about 80 g and about 600 g, more typically between about 80 g and about 450 g, although they are different from one another. More particularly, one may be configured to provide a level of force between about 80 g and about 160 g or between about 200 g and about 450 g. For example, exemplary force values may include about 80 g, about 120 g, about 160 g, about 260 g, about 300 g, about 450 g, and about 600 g. Other intermediate values may also be provided (e.g., about 180 g, about 200 g, about 220 g, about 240 g). In one embodiment, the values of any given value may vary ±5 g. Although it is preferred that the above described method be carried out with orthodontic force modules including elastomeric force members, it is also within the scope of the invention to carry out such a method in which one or more of the force modules include a coil spring force member.

FIGS. 3A-3B illustrate another orthodontic force module 200 that is similar to that shown in FIGS. 1A-1E. Force module 200 includes an elongate body 202 having a distal end 204, a proximal end 206, and an oval transverse cross-section. A movable member 208 (e.g., a piston rod) is slidably disposed through opening 214 in proximal end 206 of body 202. Movable piston 216 is disposed over distal end 210 of movable member 208, while a stop 218 may be fixedly attached to body 202 near proximal end 206. Elastomeric member 220 is cooperatively coupled at a proximal end 222 to stop 218, while a distal end 224 is cooperatively coupled with movable piston 216. In use, stop 218 anchors end 222 of elastomeric member 220, while movable member 208 is forced distally into body 202, slidably urging movable piston 216 towards distal end 204 and stretching elastomeric member 220. FIG. 3B shows this stretched configuration. When the force is released from movable member 208, movable member 208 spontaneously retracts outwardly from elongate body 202, to the configuration shown in FIG. 3A by application of force by the elastomeric member 220.

Elastomeric member 220 in this embodiment is configured and coupled to piston 216 and stop 218 somewhat differently than the embodiment of FIGS. 1A-1E. For example, elastomeric member 220 includes two elongate band portions 221 extending between a proximal disc 222 at the proximal end and a distal disc 224 at the distal end. Proximal disc 222 includes a central opening through which movable member 208 is disposed. A portion of stop 218 may also be disposed through the central opening of proximal disc 222. Stop 218 further includes a collar 219 against which proximal disc 222 abuts. Collar 219 is fixed in place relative to body 202 and prevents disc 222 from moving distally as force is applied to distal disc 224. Distal disc 224 may be similarly configured with a central opening through which movable member 208 and a portion of movable piston 216 may pass. Movable piston 216 may include a collar 217 against which distal disc 224 is engaged so as to prevent disc 224 from passing proximally over collar 217 Collar 217 (and piston 216) is movable relative to body 202, but may normally be fixed relative to distal end 210 of movable member 208 during normal operation. As movable member 208 is moved distally into elongate body 202, movable piston 216 moves with movable member 208, stretching elastomeric member 220, which is fixed at end 222 relative to elongate body 202. The illustrated configurations are only exemplary configurations for the elastomeric member and its cooperative coupling or engagement with the stop and movable piston. Alternative configurations will be apparent to those of skill in the art.

Hooks 226 and 228 allow the force module 200 to be connected to respective orthodontic brackets and/or arch wires attached to different dental arches so as to transfer the counter-force generated by the elastomeric member 220 and the movable member to the upper and lower jaws so as to effect the desired movement (see FIGS. 7A-7B).

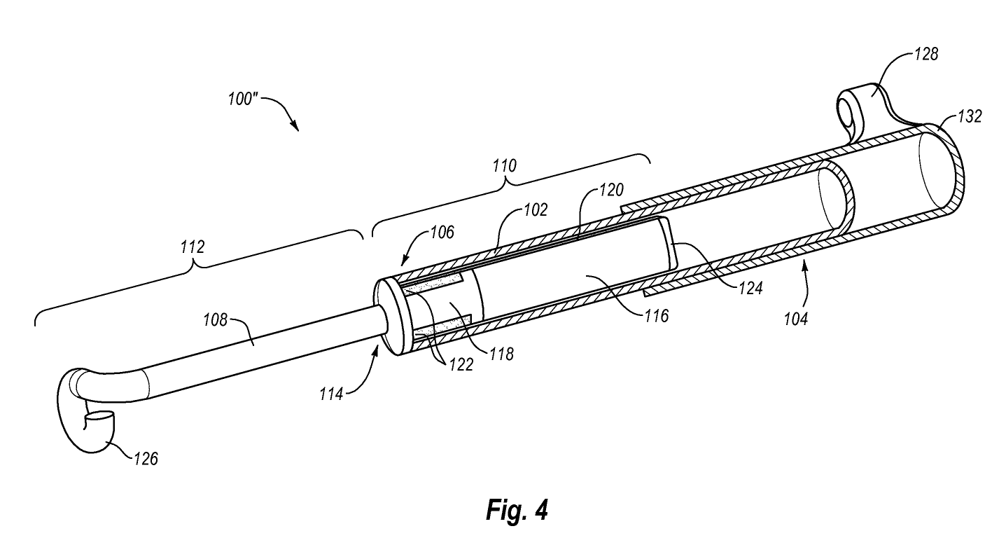

FIG. 4 shows another alternative force module 100″ that is similar to module 100 of FIGS. 1A-1E, but includes a telescoping outer housing 132 within which the distal end 104 of elongate housing 102 is slidably disposed. Elongate body 102 is able to freely slide or telescope within (and out of) the hollow interior of outer housing 132. When distal end 104 is fully inserted within outer housing 132, the overall length of device 100″ is substantially identical to that of device 100 of FIG. 1A, as the distal end 104 of elongate body 102 abuts the closed distal end of outer housing 132. As elongate body 102 slides proximally from this position, the overall length of device 100″ lengthens. Telescoping of elongate body 102 into or out of outer housing 132 increases the possible working length of device 100″, which can be helpful for patients with very wide spacing between anchoring points on the upper and lower jaws.

The additional working length of such a device allows the device to telescope so as to increase the working length when needed (e.g., when the patient yawns). Because there is little or no counter-force to telescoping movement of elongate body 102 within outer housing 132, when less working length is required (e.g., when the patient begins to close his or her mouth at the end of a yawn), elongate body 102 telescopes fully back into outer housing 132 before any substantial compression of movable member 108 occurs. This is because elastomeric member 120 applies a counter-force to any movement of movable member 108. Of course, if desired, a spring or another elastomeric member could be included to apply a counter-force against movement of elongate body 102 into outer housing 132. The availability of such additional working length prevents brackets adjacent to attachment hooks 126 and/or 128 from being undesirably debonded from their respective teeth. For this same reason, the movable member 108 associated with any of the described embodiments may be configured to allow it to be pulled completely out of piston 116 and elongate body 102.

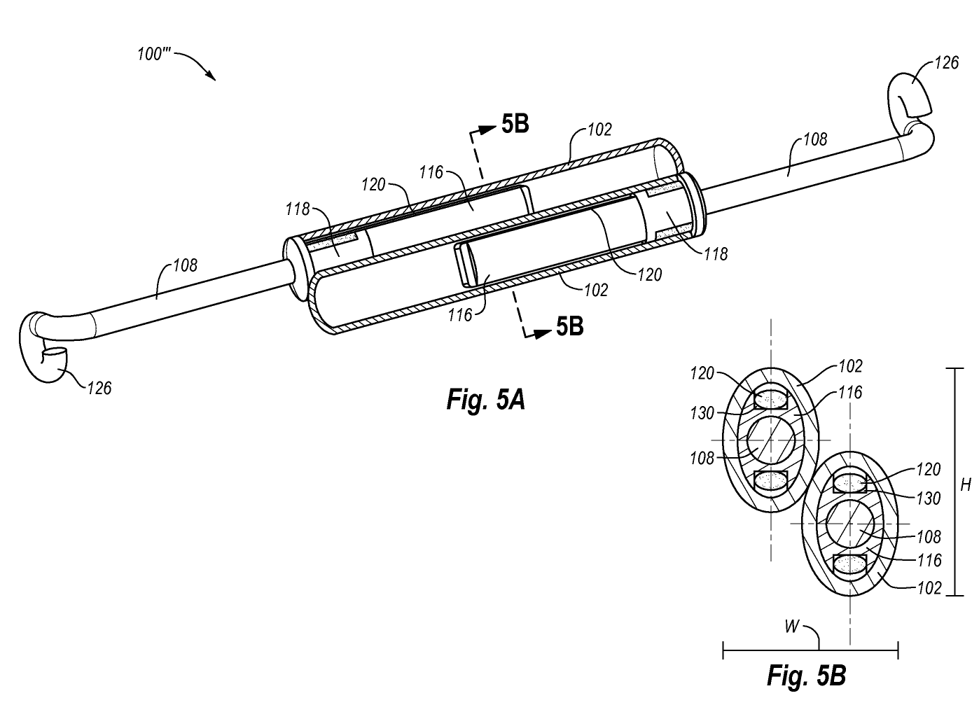

FIG. 5A shows another alternative force module 100′″ that is similar to force module 100 of FIGS. 1A-1E, but is configured as a twin elongate body module. Force module 100′″ may include essentially two modules 100 in which the elongate bodies 102 of each are attached together and oppositely oriented relative to one another so as to provide a pair of movable members 108 oppositely oriented (i.e., one movable member 108 is disposed at a proximal end of module 100′′ while the other is disposed at a distal end of module 100′″). Rather than an attachment hook 128 on elongate body 102, attachment between the upper and lower jaws is provided by hooks 126 at the ends of each movable member 108. Each movable member 108 is biased by a respective elastic member 120 so as to provide a counter-force to each movable member 108 as each movable member 108 is urged into elongate body 102.

FIG. 5B illustrates a cross-sectional view through device 100′′ and twin elongate bodies 102. As shown, each body 102 may include an oval configuration, while each oval body 102 may be offset relative to both horizontal and vertical axes of the oval bodies 102. In one embodiment the vertical axes of each body 102 may be offset but parallel to one another. Similarly, the horizontal axes of each body 102 may also be offset but parallel to one another. Such an offset configuration balances minimization of the overall width W with overall height H of device 100′″.

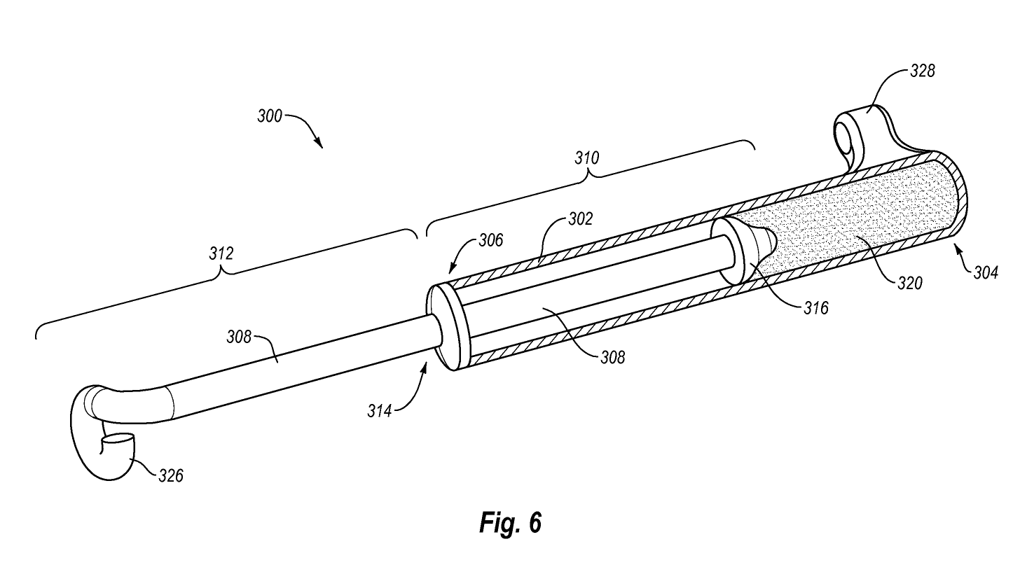

FIG. 6 shows another alternative embodiment of an orthodontic force module 300 including an elongate body 302 extending between a distal end 304 and a proximal end 306. A movable member 308 (e.g., a piston rod) also includes a distal end 310 and a proximal end 312. In the illustrated embodiment, distal end 310 is slidably disposed through opening 314 formed through proximal end 306 of body 302 so as to be disposed within a cavity in body 302. Movable member 308 includes a piston 316 disposed at its distal end. Piston 316 and movable member 308 are slidably movable within body 302.

Rather than including an elastomeric member configured as a band that undergoes tension so as to generate the desired counter-force, force module 300 includes an elastomeric member 320 (e.g., configured as a pad) disposed within the distal end 304 of elongate body 302. Such a configuration compresses elastomeric member 320 as member 308 is urged into elongate body 302, causing piston 316 to press against elastomeric member 320. Piston 316 may include any of various configurations. In the illustrated configuration, the distal contacting surface of piston 316 includes a substantially bell-shaped curved configuration. In an alternative, piston 316 may include a substantially flat distal contacting surface. A bell-shaped surface or other configuration that only contacts a portion of distal surface of piston 316 upon first contact with elastomeric member 320 provides increasing contact surface area (and thus increasing resistance) between piston 316 and elastomeric member 320 as movable member 308 is urged further into elongate body 302. Attachment between the upper and lower jaws may be provided by hooks 326 and 328.

The orthodontic force modules of the present invention may be formed by any suitable manufacturing process, for example machining, casting, metal injection molding (MIM), drawing or otherwise. Machining at least the elongate body is particularly preferred as better accuracy of the component dimensions is possible as compared to alternative techniques. Such improved accuracy provides for better fit, as well as better strength. For example, components of existing force modules are often formed by drawing tubing so as to form an elongate body. During such processes, the wall thickness of the tubing is thinned. Furthermore, drawing thicker walled tubing can be particularly difficult if not impossible. The result is that components formed by such methods typically include relatively thin wall thicknesses and are thus relative weak. Because of the reduced strength of such components, it is not uncommon for a piston rod to pull partially out of the hollow housing and then become kinked or to perforate the thin housing wall. While such devices typically have thin, weak walls, they also exhibit relatively large overall diameter widths, making them obtrusive within the small space between the cheek and the posterior teeth.

Machining the elongate housing allows the manufacturer to provide components with improved fit relative to one another, while also providing substantially improved wall thickness at the same time that overall width of the device is reduced. In other words, miniaturization of the components, increased strength, and accurate fit is possible by machining For example, a machined elongate body may include a wall thickness substantially greater than that of existing devices formed by drawing. Furthermore, the overall dimensions of the device, particularly width, is significantly less than existing devices.

Although it is preferred that the use of metal or other coil springs for providing the counter-force to the piston rod or other movable member be avoided, according to one embodiment, it is within the scope of the invention to employ such force members while providing an orthodontic force module having a non-circular cross section in which the width of the body of the module is reduced (e.g., having an oval or D-shaped cross-section) as compared to a round cross-section. Such a force module typically includes a movable member (e.g., a piston rod) and some type of force member disposed on (e.g., adjacent the exterior) or within the body that is cooperatively coupled to the movable member such that when the movable member is urged distally relative to the elongate body, the force member applies a counter-force to the movable member. Although preferably such a force member comprises an elastomeric member, it is also within the scope of the invention to alternatively employ a coil spring or other force member in such an embodiment including a non-circular body reduced width body.

Any of various silicone materials may be employed. One exemplary silicone material, KEG2000-50A/B, is available from Shin-Etsu Silicones of America, located in Akron, Ohio. Various other Shin-Etsu silicone products and silicone materials from other suppliers can also be used.

Examples of thermoplastic elastomers that may be used include styrene-ethylene-butylene-styrene (SEBS) and VERSAflex, a proprietary thermoplastic elastomer alloy that exhibits elastic elongation and other properties similar to silicone. VERSAflex is sold by GLS Corporation, based in McHenry, Ill. A suitable example of a SEBS material is SEBS TPE 45A, available from various providers.

Several exemplary VERSAFLEX thermoplastic elastomer materials, including VERSAFLEX CL30 and VERSAFLEX CL40, are available from GLS Corporation, located in McHenry, Ill. Various other VERSAFLEX products from GLS Corporation can also be used.

Examples of additional elastomeric silicone and silicone-like thermoplastic elastomer materials that may be suitable for use are listed in the table below.

| | | | | % |
|---|---|---|---|---|
| | | Product | Shore A | Elon- |
| Manufacturer | Product | Type | Hardness | gation |
| Shin-Etsu | SVX-19550C-7 | Silicone | 50 | 640 |
| Wittenburg B.V. | MT 970 | SEBS | 70 | |
| Wittenburg B.V. | Cawiton PR 2677F | SEBS | 25 | |
| Teknor Apex | MP 1870-1000 | SEBS-TPE | 70 | 600 |
| Bayer | Texin 985 | TPE | 86 | 500 |
| | | (Polyether) | | |
| Bayer | Texin 285 Natural | TPE | 85 | 500 |
| | | (Polyether) | | |
| Bayer | Texin 1201 | TPE | 67 | 300 |
| GLS Corp. | Versaflex - CL 30 | TPE | 30 | 780 |
| GLS Corp. | Versaflex - CL 40 | TPE | 43 | 690 |
| GLS Corp. | Versaflex 2250 | TPE | 50 | 760 |
| GLS Corp. | Versalloy 9055X-1 | TPE | 53 | 590 |
| GLS Corp. | Dynaflex G2701- | TPE | 66 | 590 |
| | 1000-02 | | | |
| GLS Corp. | Dynaflex G 2703- | TPE | 58 | 690 |
| | 1000-02 | | | |
| Dow Corning | TPSiV 3010 | TPE | 50 | 470 |
| Dow Corning | TPsiV 3040-55A | TPE | 55 | 450 |
| Dow Corning | LSR C6-550 | Silicone | 55 | 661 |
| Dow Corning | LSR C6-570 | Silicone | 70 | 442 |
| Dow Corning | Silastic Dev SB 2% | Silicone | 50 | 450 |
| | bleed | | | |
| JRS | Excelink 1600B | TPE | 56 | 640 |
| PolyOne | Elastamax EG-9065 | TPE | 65 | 420 |
| Advance | Duragrip DGR 6250 | TPE | 50 | 800 |
| Polymers | CL | | | |
| Elastocon | Elastocon 2840 | TPE | 40 | 580 |
| Elastocon | Elastocon 2855 | TPE | 55 | 660 |
| Kraiburg | Thermolast TF4THT | TPE | 40 | 610 |
| Kraiburg | Thermolast TF5THT | TPE | 50 | 680 |
| Kraiburg | Thermolast TF6THT | TPE | 60 | 710 |
| AT Plastics | Ateva 2810A | EVA-C | 79 | 820 |
| Arkema | Evatane 33-400 | EVA | 55 | 950 |

FIG. 7A shows force module 100 installed so as to provide a force configured to correct a class II malocclusion. Proximal hook 126 is connected to the arch wire or bracket near the patient's canine of the lower jaw. Distal hook 128 is connected to the arch wire or bracket at a location near the patient's first molar of the upper jaw. When the patient's mouth is closed (FIG. 7A) the distance between the lower canine and upper first molar is such that movable member 108 is urged at least partially into elongate body 102. This results in stretching of elastomeric member 120, applying a counter-force to piston rod 108, which is transferred through hook 126 to the lower jaw, as hook 128 anchors the distal end of force module 100 relative to the upper jaw. Application of the counter-force progressively forces the lower jaw forward, correcting the class II malocclusion. When the patient opens his or her mouth (FIG. 7B), the distance between the lower canine and upper first molar (i.e., attachment points of hooks 126 and 128, respectively) increases, causing movable member 108 to at least partially retract from elongate body 102, decreasing the applied counter-force. When the patient again closes their mouth, the configuration of FIG. 7A is reassumed. Correction of a class III malocclusion may be accomplished by opposite attachment of the force module. In other words, proximal hook 126 is connected to the arch wire or bracket near the patient's canine of the upper jaw, while distal hook 128 is connected to the arch wire or bracket at a location near the patient's first molar of the lower jaw.

FIG. 7C illustrates how the preferred substantially oval cross-section is particularly advantageous in minimizing the width of the force module 100 so as to be less uncomfortable for the patient. Space can be very limited between the posterior teeth 150 of the jaw and the interior soft buccal tissue 152 of the cheek. Minimization of the width of the force module in this area is particularly helpful in reducing irritating contact between the soft interior tissues of the cheek with the force module. For example, an oval cross-sectioned device having a ratio of width to height of about 1.5:1 provides a one-third reduction in width as compared to a round cross-sectioned device of the same height.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. An orthodontic force module for use in correcting class II and/or class III malocclusions, the force module comprising:
at least one elongate body extending between a distal end and a proximal end;
at least one movable member extending between a distal end and a proximal end, the distal end of the movable member being slidably disposed relative to the elongate body;
at least one movable piston disposed at or near the distal end of the movable member;
at least one stop disposed at or near the proximal end of the elongate body, the stop being proximally disposed relative to the movable piston; and
at least one elastomeric member cooperatively coupled to the stop at or near an end of the elastomeric member, the elastomeric member being cooperatively coupled to the movable piston at or near another end of the elastomeric member such that when the movable member is moved distally relative to the elongate body, the elastomeric member stretches so as to apply a counter-force to the movable member.

2. An orthodontic force module as recited in claim 1, further comprising a first attachment means disposed at or near the proximal end of the movable member for attachment to a bracket and/or arch wire and a second attachment means disposed at or near the distal end of the body for attachment to an arch wire and/or another bracket.

3. An orthodontic force module as recited in claim 1, wherein the elastomeric member comprises silicone or a thermoplastic elastomer.

4. An orthodontic force module as recited in claim 1, wherein the elongate body comprises an elongate housing and the distal end of the movable member is slidably received within the proximal end of the housing, and wherein the movable piston, the stop, and the elastomeric member are housed within the housing.

5. An orthodontic force module as recited in claim 4, wherein the elongate housing is closed to the exterior except for an opening at the proximal end of the housing that receives the distal end of the movable member so as to seal the interior of the housing and prevent contamination of components within the housing.

6. An orthodontic force module as recited in claim 5, wherein the movable member comprises an elongate piston rod, the distal end of the piston rod being slidably disposed through the opening at the proximal end of the housing.

7. An orthodontic force module as recited in claim 1, wherein the elongate body has a transverse cross-section that is substantially circular.

8. An orthodontic force module as recited in claim 1, wherein the elongate body has a transverse cross-section that is substantially oval.

9. An orthodontic force module as recited in claim 8, wherein a ratio of a long axis H relative to a short axis W of the oval is between about 1.1:1 and about 2:1.

10. An orthodontic force module as recited in claim 8, wherein a ratio of a long axis H relative to a short axis W of the oval is between about 1.3:1 and about 1.7:1.

11. An orthodontic force module as recited in claim 8, wherein a ratio of a long axis H relative to a short axis W of the oval is between about 1.4:1 and about 1.6:1.

12. An orthodontic force module as recited in claim 1, wherein the force module is a twin configuration.

13. An orthodontic force module as recited in claim 1, wherein the force module further comprises a telescoping outer housing into which the distal end of the elongate body telescopingly slides.

14. An orthodontic force module for use in correcting class II and/or class III malocclusions, the force module comprising:
at least one elongate body extending between a distal end and a proximal end, the elongate body having a transverse cross-section that is substantially oval;
at least one movable member extending between a distal end and a proximal end, the distal end of the movable member being slidably disposed relative to the body;
at least one movable piston disposed at or near the distal end of the movable member;
at least one fixed stop disposed at or near the proximal end of the body, the fixed stop being proximally disposed relative to the movable piston; and
at least one elastomeric member cooperatively coupled to the fixed stop at or near an end of the elastomeric member, the elastomeric member being cooperatively coupled to the movable piston at or near another end of the elastomeric member such that when the movable member is moved distally relative to the body, the elastomeric member stretches so as to apply a counter-force to the movable member.

15. An orthodontic force module as recited in claim 14, wherein a ratio of a long axis H relative to a short axis W of the oval is between about 1.4:1 and about 1.6:1.

16. An orthodontic force module for use in correcting class II and/or class III malocclusions, the force module comprising:
at least one elongate housing extending between a distal end and a proximal end;
at least one elongate piston rod extending between a distal end and a proximal end, the distal end of the elongate piston rod being slidably disposed within the proximal end of the housing;
at least one slidable piston disposed so as to slide within the housing, the slidable piston being disposed at the distal end of the elongate piston rod;
at least one fixed stop disposed at or near the proximal end of the housing; and
at least one elastomeric member cooperatively coupled to the fixed stop at an end of the elastomeric member, another end of the elastomeric member being cooperatively coupled to the slidable piston such that when the piston rod and slidable piston are moved into the housing, the elastomeric member stretches so as to apply a counter-force to the piston rod.

17. An orthodontic force module as recited in claim 16, wherein the elongate body has a transverse cross-section that is substantially oval and wherein a ratio of a long axis H relative to a short axis W of the oval is between about 1.4:1 and about 1.6:1.

18. An orthodontic force module as recited in claim 16, wherein the elastomeric member comprises silicone or a thermoplastic elastomer, wherein the silicone or thermoplastic elastomer has an elastic elongation of at least about 50%.

19. An orthodontic force module for use in correcting class II and/or class III malocclusions, the force module comprising:
at least one elongate body extending between a distal end and a proximal end;
at least one movable member extending between a distal end and a proximal end, the distal end of the movable member being slidably disposed within the proximal end of the elongate body;
at least one elastomeric member on or within the elongate body against which the movable member presses when the movable member is urged into the elongate body such that when the movable member is moved distally relative to the elongate body, the elastomeric member applies a counter-force to the movable member.

20. An orthodontic force module for use in correcting class II and/or class III malocclusions, the force module comprising:
at least one elongate body extending between a distal end and a proximal end, the elongate body having a transverse cross-section that is substantially oval or D-shaped so as to have a long axis H that is larger than a short axis W;
at least one movable member extending between a distal end and a proximal end, the distal end of the movable member being slidably disposed relative to the body;
at least one force member disposed on or within the elongate body, the force member being cooperatively coupled to the movable member such that when the movable member is urged distally relative to the elongate body, the force member applies a counter-force to the movable member.

21. An orthodontic force module as recited in claim 20, wherein the force member comprises an elastomeric member.
